(19) United States
(12) Patent Application Publication
(10) Pub. No.: US 2009/0237497 A1
(43) Pub. Date: Sep. 24, 2009

(54) ENDOSCOPE CAMERA HEAD AND METHOD FOR MANUFACTURING THE SAME

(75) Inventors: Sei Iinuma, Akishima-shi (JP); Akihiro Oohashi, Oume-shi (JP); Masatoshi Ookubo, Iruma-shi (JP); Takumi Murakami, Hidaka-shi (JP); Kazutoshi Araki, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/333,999

(22) Filed: Dec. 12, 2008

(30) Foreign Application Priority Data
Mar. 18, 2008 (JP) 2008-069723

(51) Int. Cl. H04N 7/18

(52) U.S. Cl. 348/65

(57) ABSTRACT

An endoscope camera head includes: an image pickup device that is configured to capture an image of an optical image and output an imaging signal containing the captured image; and a lens member that includes a lens for forming the optical image on the image pickup device, wherein the image pickup device is fixed to the lens member at a position in which the center of an image circle of the lens and the center of an image pickup area of the image pickup device coincide with each other.

### CROSS REFERENCE TO RELATED APPLICATION(S)

The present disclosure relates to the subject matters contained in Japanese Patent Application No. 2008-069723 filed on Mar. 18, 2008, which are incorporated herein by reference in its entirety.

### FIELD

The present invention relates to an endoscope camera head and a method for manufacturing the endoscope camera head.

### BACKGROUND

Endoscopes are used to observe inside a subject to be observed by inserting the endoscopes inside the subject. The known endoscopes include a medical endoscope for observing inside a body cavity and an industrial endoscope for observing inside a structure such as a pipe or a machine. Such an endoscope has a camera head (also called an insertion section) that is inserted into the body cavity or the structure, a camera control unit (also called an endoscope body) for processing a signal received from the camera head, and a cable that connects the camera head and the camera control unit.

An example of the conventional electronic endoscope is disclosed in JP-2002-301012-A. The electronic endoscope disclosed in this publication is provided with a camera head including a cover glass that is disposed in front of a CCD (Charge Coupled Devices) and an optical lens that is disposed in front of the cover glass.

In the conventional endoscope, as the electronic endoscope disclosed in the aforementioned publication, the optical lens and the CCD are fixed in its position in the camera head.

However, in the conventional endoscope, positions of the optical lens and the CCD are fixed so that an image pickup area of the CCD is positioned within an image circle (a circular range in which light transmitted thorough the optical lens is imaged on the CCD) of the optical lens.

In this case, as shown in FIG. 12A, when the image pickup area AR of the CCD is deviated form the image circle C, the image formed by the optical lens might be deviated from the image pickup area AR of the CCD, whereby an image loss may be caused. Hence, in the conventional camera head, in order to assure the position of the image pickup area AR of the CCD to be within the image circle C, a margin is set by increasing a size of the image circle C, as shown in FIG. 12B. Accordingly, in the conventional camera head, the size of the optical lens should be set by a predetermined value, and thus it is difficult to reduce an exterior size of the camera head that houses the optical lens.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a block diagram showing a primary configuration of a camera apparatus according to an embodiment of the invention.

FIG. 2 is a sectional side view of a head casing showing a primary configuration of the inside of a camera head.

FIG. 3 is a side view showing an image pickup unit.

FIG. 4 is a diagram showing an example of an image pickup unit and a chart used in a CCD positioning.

FIG. 5 is a diagram showing an example of relation between the image circle and the image pickup area.

FIG. 6 is a diagram showing an example of a monitor and an image displayed thereon.

FIG. 7 is a diagram showing an example of a front end part structure of a different camera head.

FIG. 8 is a sectional side view of a head casing additionally showing a primary configuration of the inside of the different camera head.

FIG. 9 is a perspective view showing a configuration of a camera head in a different camera apparatus according to the invention.

FIG. 10 is a side view showing a TAB CCO.

FIG. 11 is a perspective view showing a CCD and a cover glass before CCD positioning.

FIGS. 12A and 12B are diagrams showing an example of relation between an image circle and an image pickup area, wherein FIG. 12A is a diagram showing an example of a case where the image pickup area is deviated from the image circle, and FIG. 12B is a diagram showing an example of a case where the image pickup area is included in the image circle and the image circle has a margin.

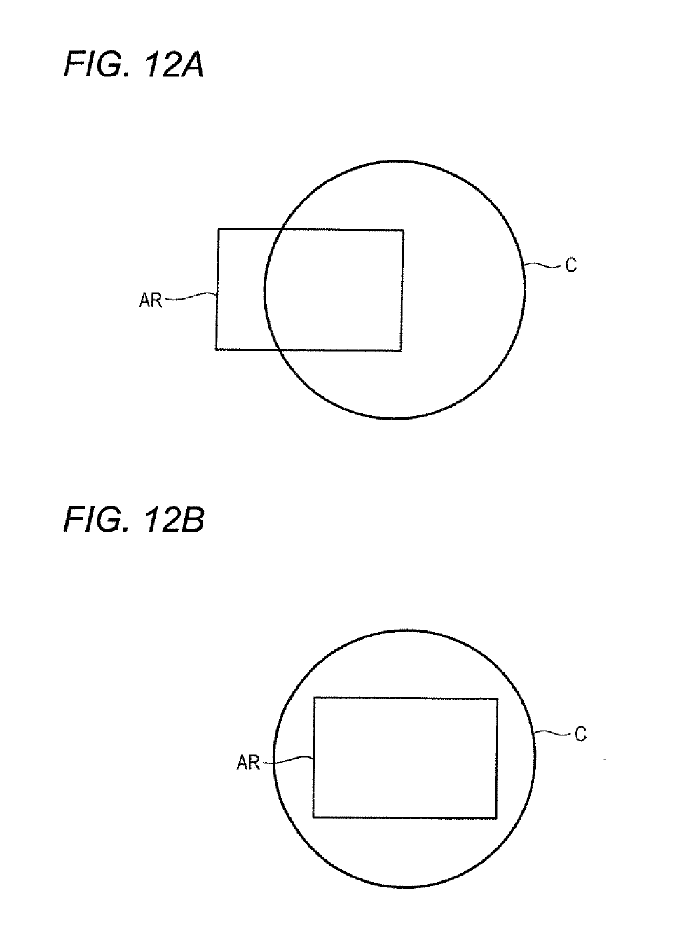

### DETAILED DESCRIPTION OF THE EMBODIMENTS

Hereinafter, embodiments of the invention will be described. In the following description, the same or similar components will be referenced by the same reference numerals, and detailed description thereof will be omitted.

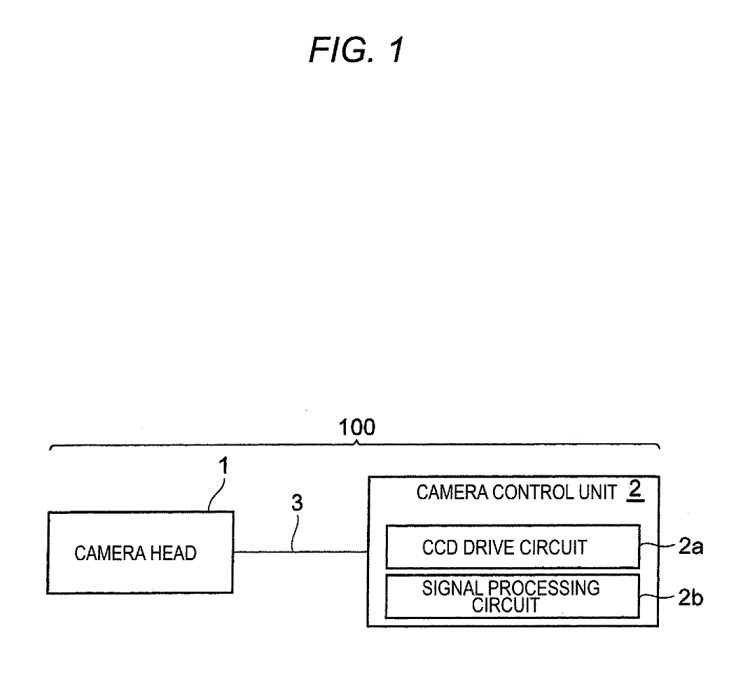

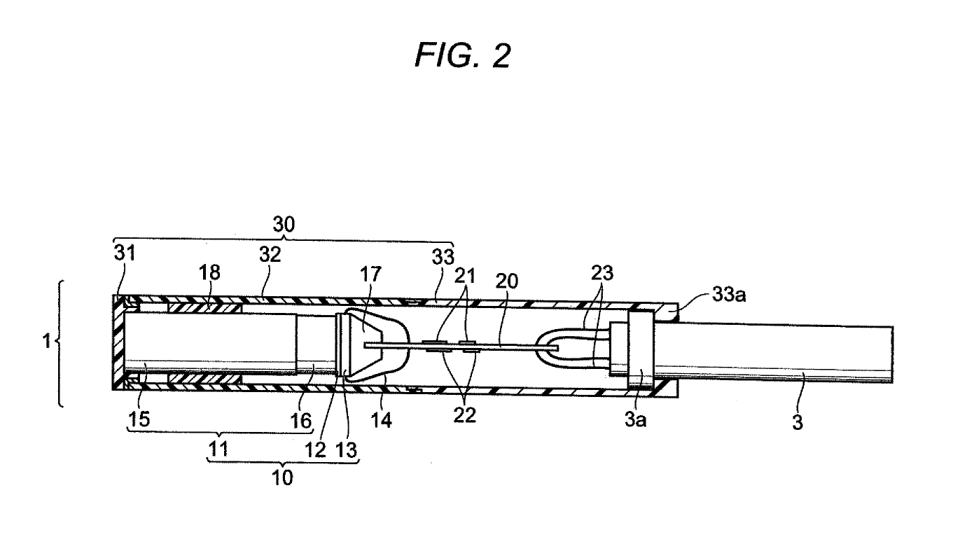

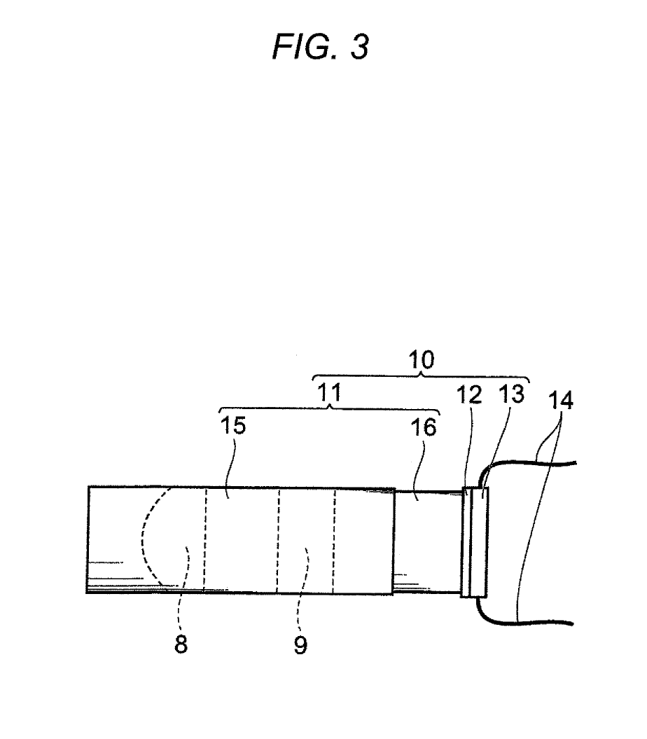

FIG. 1 is a block diagram showing a configuration of a camera apparatus 100 according to an embodiment of the invention. FIG. 2 is a sectional side view of a head casing showing inside of a camera head. FIG. 3 is a side view showing an image pickup unit.

As shown in FIG. 1, the camera apparatus 100 has a camera head 1, a camera control unit 2 (hereinafter simply referred to as “CCU”), and a camera cable 3 that connects the camera head 1 and the camera control unit 2.

The camera head 1, as shown in FIG. 2, has an image pickup unit 10, a substrate holder 17, a position fixing ring 13, a circuit board 20, a wire 23, and a head casing 30. The camera head 1 is configured so that the head casing 30 houses the image pickup unit 10, the substrate holder 17, the position fixing ring 18, the circuit board 20, and the wire 23.

The image pickup unit 10, as shown in FIG. 3, has a lens block 11 and a CCD 13. As described later, by CCD positioning the center of an image circle 51 is made to coincide with the center of an image pickup area 52, and the CCD 13 is fixedly attached to the lens block 11 by an optical adhesive 12.

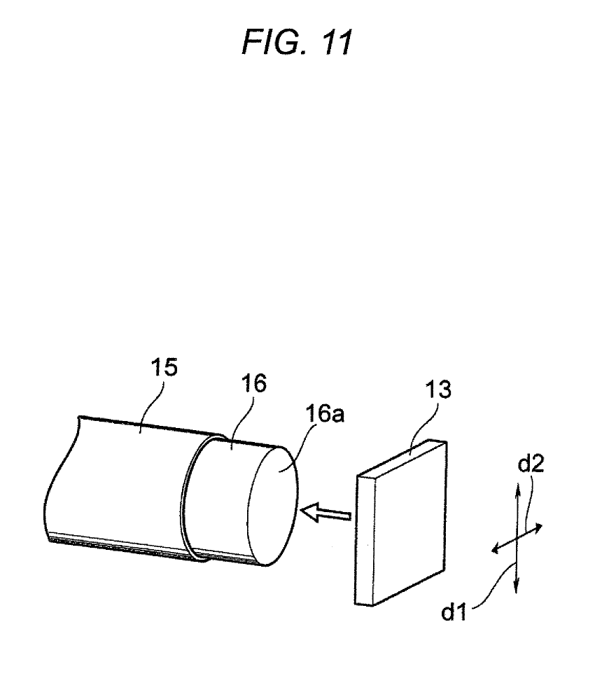

The lens block 11 has a lens barrel section 15 as a tubular member housing optical lenses 8 and 9 therein and a cover glass 16 having a cylindrical shape fixedly attached to one axial end portion of the lens barrel section 15. In addition, the CCD 13 is fixedly attached by the optical adhesive 12 to a section 16a (see FIG. 11) on a side of the cover glass 16 that is not attached to the lens barrel section 15.

The CCD 13 is an image pickup device that generates an imaging signal based on an optical image formed by the optical lenses 8 and 9 and outputs the imaging signal to the outside through the lead wire 14. In addition, the CCD 13 is formed by a TAB CCD (a CCD of which a chip size is substantially equal to a package size thereof).

The lead wire 14 is soldered to a circuit board 20, and is provided so as to output the imaging signal generated from the CCD 13 and supply power and drive pulse from the circuit board 20 to the CCD 13.

In addition, the image pickup unit 10 is housed in the head casing 30 in a state where the position fixing is ring 18 is mounted on the lens barrel section 15. The position fixing ring 18 is a tubular member having a size corresponding to inner circumference of the head casing 30, and is for fixing a position thereof in the head casing 30 of the image pickup unit 10.

The substrate holder 17 is a member fixedly attached to an end of the CCD 13 of an opposite side that is not fixedly attached to the lens block 11, and fixing a position thereof by inserting the circuit board 20 therein. On the circuit board 20, circuit line patterns to which the imaging signal output from the CCD 13 is input are formed on each of an upper surface and a lower surface thereof, and electronic components 21 and 22 for processing the imaging signal is mounted on the line pattern. The circuit board 20 is connected to the CCD 13 through the lead wire 14, and is connected to the cable 3 through a wire 23. The wire 23 fixedly attached to the circuit board 20 and the cable 3 by being soldered.

The head casing 30 is integrally formed by combining a front cover 31, a barrel member 32 in which the front cover 31 is mounted on a front end portion thereof, a barrel member 33 in which the barrel member 32 is mounted on a front end portion thereof. In addition, in the head casing 30, in order from the rear end portion of the barrel member 33, the image pickup unit 10 in which the position fixing ring 18 is mounted on the lens barrel section 15, the substrate holder 17, the circuit board 20, and the front end portion of the cable 3 connected to the wire 23 are inserted, and coking 3a is locked by a locking portion 33a of the barrel member 33.

The CCU 2 has a drive circuit 2a generating a drive signal for driving the CCD 13, and a signal processing circuit 2b performing amplification of the imaging signal input from the camera head 1 through the camera cable 3, D/A conversion, video signal generation for displaying an image on a display device, and the like.

In the camera apparatus 100, the camera head 1 is inserted into the inside of a subject, an optical image of the inside of the subject is imaged on the CCD 13 by optical lenses 8 and 9, and an imaging signal based on the optical image is output from the CCD 13. The imaging signal is processed by electronic components on the circuit board 20 through the lead wire 14, and then is input from the wire 23 to the CCU 2 through the camera cable 3.

Furthermore, a video signal output from the CCU 2 is guided to the display device not shown in the drawings, and thus the subject taken by the camera head 1 can be observed by displaying an image on the display device.

However, as described above, the image pickup unit 10 is manufactured by performing the CCD positioning that makes the center of the image circle 51 coincide with the center of the image pickup area 52, and fixedly attaching the CCD 13 to the lens block 11 in a state where both of the centers coincide with each other. The CCD positioning is performed as follows.

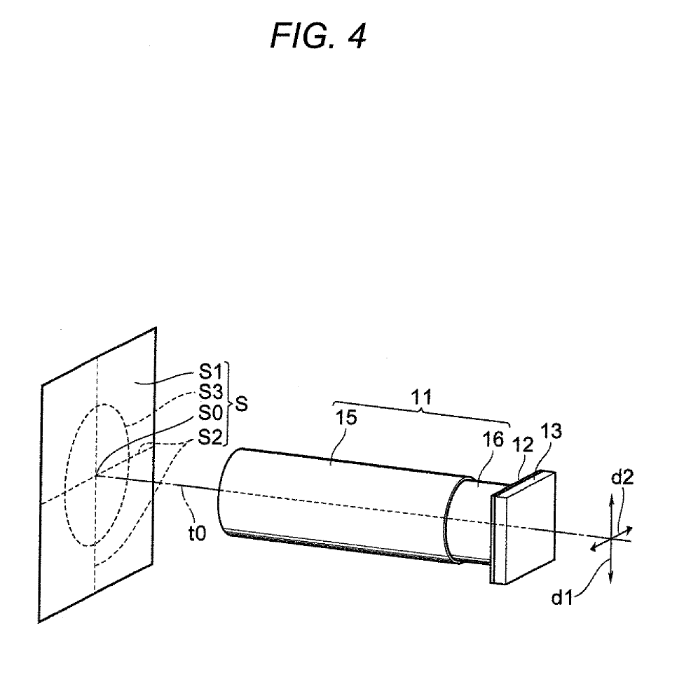

In the CCD positioning according to embodiment, as shown in FIG. 4, a chart S for adjusting the position is used. The chart S is depicted on a planar wall, in which on a rectangular area S1 having a size capable of being captured by the image pickup unit 10, a cross line S2 passing through a center point S0 thereof and a positioning circle 53 centered on the center point S0 are depicted.

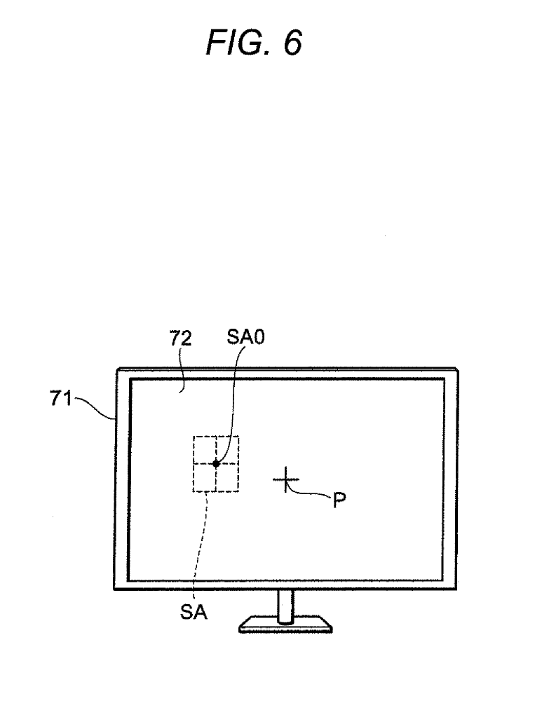

When the chart S is captured by the image pickup unit 10, the optical image of the chart S is imaged on the CCD 13 by the optical lenses 8 and 9. Accordingly, a monitor 71 is provided as shown in FIG. 6, and the imaging signal of the CCD 13 is guided into the monitor 71 through the lead wire 14, the circuit board 20, the wire 23, and the cable 3. Thus, it is possible to display a chart image SA showing the chart S on a display section 72 of the monitor 71. On the display section 72, a cross-shaped mark P previously showing a center position of the display section 72 is depicted.

When the CCD positioning is performed, first, as shown in FIG. 4, the front end side of the lens block 11 to which the CCD 13 is not fixedly attached is made to face toward the chart S, and then the lens barrel section 15 is held by a predetermined holding member. At this time, the CCD 13 is held together with the lens barrel section 15 so that the chart image SA is displayed on the display section 72, and thus the position of the lens barrel section 15 is determined so that an optical axis t0 of the optical lenses 8 and 9 points to the center point S0 of the chart S.

The image taken by the CCD 13 can be displayed on the display section 72 of the monitor 71, and thus the CCD positioning is performed while observing the display section 72. Then, the position of the CCD 13 is adjusted so that the center point SAO of the chart image SA coincides with the center point P of the display section 72. At the time when the center point S0 of the chart image SA coincides with the center point P, moving the position of the CCD 13 is stopped, the CCD 13 is adhered to the cover glass 16 by the optical adhesive 12 in a state where the center point S0 coincides with the center point P.

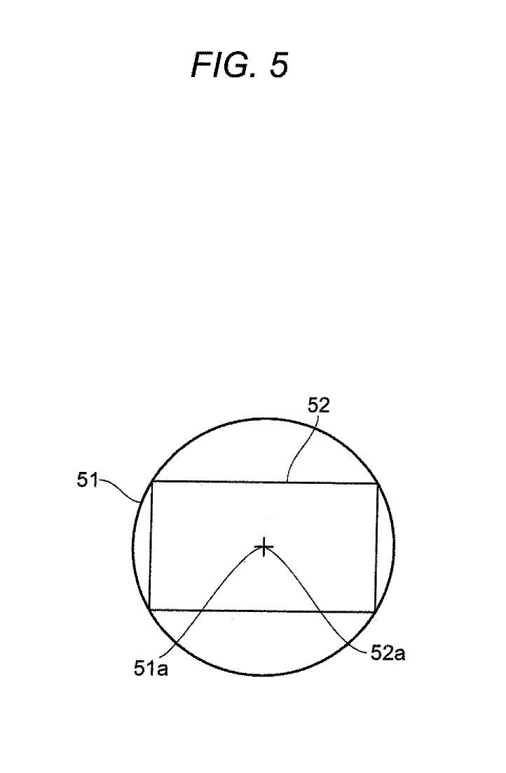

Since the optical axis t0 of the optical lenses 8 and 9 points to the center point S0 of the chart S, the center 51a of the image circle 51 of the optical lenses 8 and 9 overlaps with the center point P of the display section 72. Then, by adjusting the position of the CCD 13 as described above, position of the CCD 13 is adjusted with respect to the optical axis t0 of the optical lenses 8 and 9, and thus as shown in FIG. 5, it is possible to make the center 51a of the image circle 51 of the lenses 8 and 9 coincide with the center 52a of the image pickup area 52 of the CCD 13. The camera head 1 is manufactured by fixedly attaching the CCD 13 to the cover glass 16 in the state where both of the centers coincide with each other.

With such a configuration, it is possible to obtain the image pickup unit 10 formed so that the center 51a of the image circle 51 coincides with the center 52a of the image pickup area 52.

As described above, in the camera head 1, the CCD 13 is fixedly attached to the lens block 11 in the state where the center 51a of the image circle 51 coincides with the center 52a of the image pickup area 52 by the CCD positioning. Thus, it is not necessary to make the image circle 51 have an unnecessary margin set so that the image pickup area 52 is not deviated from the image circle 51. Specifically, as shown in FIG. 5, the image pickup area 52 has a rectangular shape, but it is possible to decrease a size of the image circle 51 as small as possible in a condition where four corners thereof are entirely overlapped with a circumferential edge of the image circle 51. Accordingly, the image pickup area 52 is just fitted to the inside of the image circle 51, and thus loss of the image taken by the CCD 13 is not caused.

As a result, since the image circle 51 decreases as the unnecessary margin of the image circle 51 is not needed. Thus, it is possible to downsize the exteriors of the optical lenses 8 and 9, and thereby it is also possible to narrow the lens barrel section 15 housing the optical lenses 8 and 9. Accordingly, it is also possible to reduce the size of the head casing 30 housing the image pickup unit 10, and it is also possible to downsize the exterior of the camera head 1, whereby downsizing is achieved.

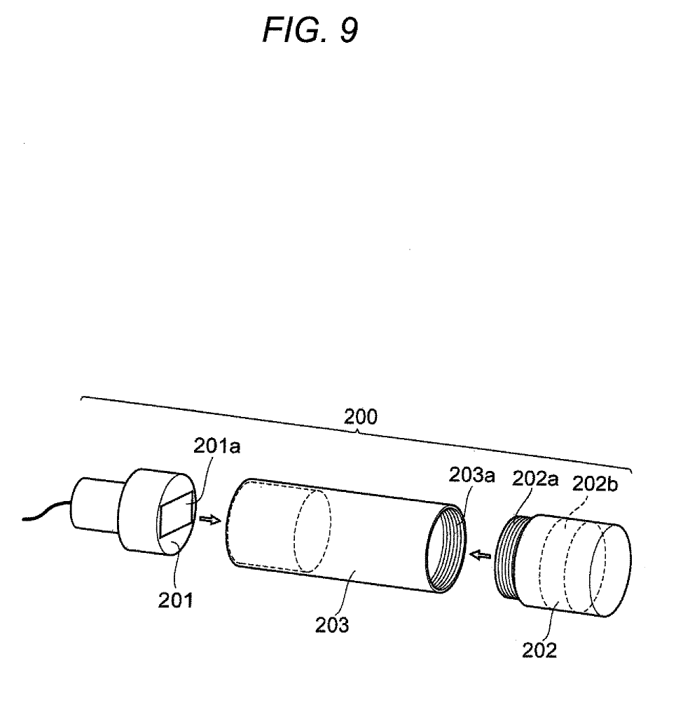

Meanwhile, FIG. 9 shows a camera head 200 in relation to the camera head 1. The camera head 200 has a CCD unit 201 having a CCD 201a fixed thereon and having a cylindrical shape, a screw section 202a provided on one end portion thereof, a lens barrel section 202 housing an optical lens 202b, a barrel member 203 for integrating the CCD unit 201 and the lens barrel section 202.

The camera head 200 is manufactured by mounting respectively the CCD unit 201 and the lens barrel section 202 on both side of the barrel member 203. However, positions of the CCD 201a and the lens 202b are determined under the condition where the image pickup area of the CCD 201a is just not deviated from the image circle of the lens 202b, that is, the image pickup area of the CCD 201a is just included in the image circle. In this camera head 200, in order to make the image pickup area of the CCD 201a be certainly included in the image circle even when the center of the image circle of the lens 202b is deviated from the center of the image pickup area of the CCD 201a or an exterior size of the CCD 201a is not uniform, it has been needed to secure a margin by properly increasing a size of the image circle. Hence, it is necessary to increase a size of the lens 200b, and thus it is very difficult to downsize the exterior of the barrel member 203.

However, the camera head 1 is manufactured by performing the aforementioned CCD positioning that makes the center 51a of the image circle 51 coincide with the center 52a of the image pickup area 52, and adhering the CCD 13 to the cover glass 16 in that state. With such a configuration, the camera head 1 is not effected by non-uniformity in the exterior size of the CCD, and by deviation between the center of the image pickup area and a center a of the image circle similar to the camera head 200. Thus, there is no unnecessary margin of the image circle 51. As the unnecessary margin of the image circle 51 is eliminated, it is possible to design to downsize the optical lenses 8 and 9. Thus, it is possible to downsize the exterior of the camera head 1.

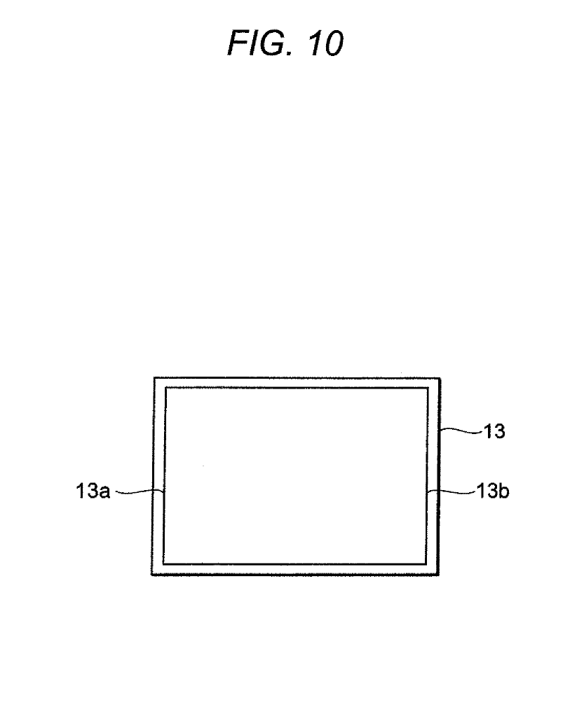

In particular, as shown in FIG. 10, the CCD 13 is formed by the TAB CCD of which a size of a chip 13b is substantially equal to a size of a package 13a (for example, in a case of 1/10 CCD, about 2 mm×2 mm). In this case, a part that have an influence caused by non-uniformity in the exterior size on the image pickup area decreases. Therefore, it is possible to more downsize the image circle 51, and thus it is further advantageous in downsizing of the camera head 1.

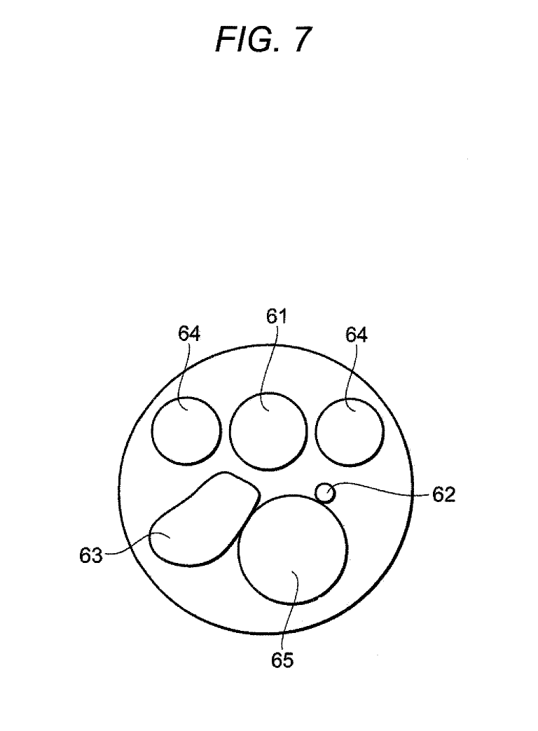

Furthermore, as the image pickup unit 10 is downsized, the head casing 30 can have more space therein, and thus the camera head 1 is appropriate to a medical endoscope 60 that needs a plurality of members as shown in FIG. 7. The medical endoscope 60 has an objective lens 61, a water-jet nozzle 62, an exhaust nozzle 63, a light guide 64, and a forceps channel 65.

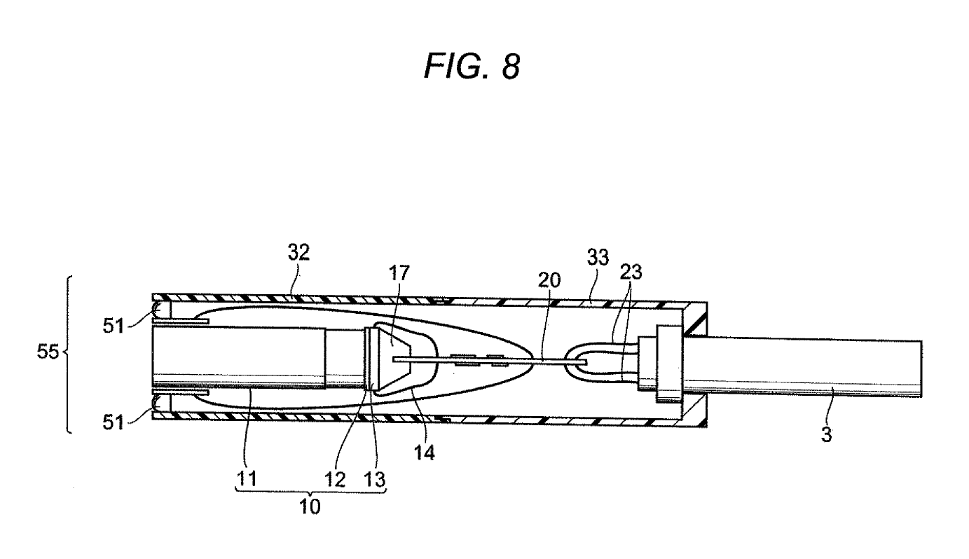

Furthermore, the image pickup unit 10 is downsized, and thus, as shown in FIG. 8, is appropriate to an endoscope camera head 55 that has an illumination LED 51 and the image pickup unit 10 in a head casing 35 and can illuminate the subject by using the illumination LED 51. The head casing 35 is formed of a barrel member 31 and a barrel member 32.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An endoscope camera head comprising:
an image pickup device that is configured to capture an image of an optical image and output an imaging signal containing the captured image; and
a lens member that comprises a lens for forming the optical image on the image pickup device,
wherein the image pickup device is fixed to the lens member at a position in which the center of an image circle of the lens and the center of an image pickup area of the image pickup device coincide with each other.

2. The endoscope camera head according to claim 1, wherein the lens member further comprises:
a tubular member that houses the lens; and
a cover glass that is fixedly attached to one axial end portion of the tubular member, and
wherein the image pickup device is fixed to the cover glass.

3. The endoscope camera head according to claim 2, wherein the image pickup device is fixed to the cover glass by an adhesive.

4. The endoscope camera head according to claim 1, wherein the image pickup area has a rectangular shape having four corners being overlapped with a circumferential edge of the image circle.

5. The endoscope camera head according to claim 1, wherein the image pickup device is configured to have a chip size and a package size that are substantially equal to each other.

6. A method for manufacturing an endoscope camera head having an image pickup device that is configured to capture an image of an optical image and output an imaging signal containing the captured image and a lens member that includes a lens for forming the optical image on the image pickup device, the method comprising:
positioning the center of an image circle of the lens and the center of an image pickup area of the image pickup device to coincide with each other; and
fixing the image pickup device to the lens member in the state where the center of the image circle of the lens coincides with the center of the image pickup area of the image pickup device.

7. The method according to claim 6, wherein an adhesive is used for fixing the image pickup device to the lens member.
